(19) United States
(12) Patent Application Publication
(10) Pub. No.: US 2025/0148294 A1
(43) Pub. Date: May 8, 2025

(54) CONDITIONAL ACOUSTIC LIBRARY GENERATION FOR DISTRIBUTED FIBER OPTIC SENSOR

(71) Applicant: NEC Laboratories America, Inc., Princeton, NJ (US)

(72) Inventors: Philip Ji, Cranbury, NJ (US); Shaobo Han, Princeton, NJ (US); Ting Wang, West Windsor, NJ (US)

(21) Appl. No.: 18/922,807

(22) Filed: Oct. 22, 2024

Related U.S. Application Data
(60) Provisional application No. 63/595,872, filed on Nov. 3, 2023.

(51) Int. Cl. G06N 3/096; G01H 9/00

(52) U.S. Cl. CPC G06N 3/096; G01H 9/004

(57) ABSTRACT

Systems and methods include calibrating physical parameters of acoustic data using a deterministic model related to hardware configurations that generated the acoustic data to provide an intermediate layer of data. The intermediate layer of data is then calibrated using environmental factors related to the acoustic data by employing machine learning to provide a multichannel data output. A loss is optimized between the multichannel data output and multichannel distributed-optic fiber sensing (DFOS) data to train a hybrid transfer model to translate between DFOS data and acoustic data.

### RELATED APPLICATION INFORMATION

This application claims priority to U.S. Provisional Patent Application No. 63/595,872 filed on Nov. 3, 2023, incorporated herein by reference in its entirety.

### BACKGROUND

### Technical Field

The present invention relates to optical fiber sensing, and more particularly, to systems and methods that employ an existing acoustic library to generate synthetic multichannel distributed fiber optic sensing (DFOS) data according to targeted deployment domains using artificial intelligence (AI).

### Description of the Related Art

Distributed fiber optic sensing (DFOS) technology uses optical fiber as a sensing medium to measure different environmental phenomena such as temperature, strain, vibration, and acoustic signals. This is typically done by sensing laser pulses into the optical fiber and then measuring and analyzing the backscattered light generated from the fiber to provide highly sensitive information with fine resolution in real-time. This technology can be used in a wide range of applications, such as perimeter security, traffic monitoring, civil infrastructure health monitoring, etc.

A major type of DFOS system is the distributed acoustic sensor (DAS) distributed vibration sensor (DVS) based on its function and capability of detecting acoustic and vibration signals in a distributed manner. These sensors involve phase sensitive optical time-domain reflectometry (ϕ-OTDR) or coherent optical time-domain reflectometry (C-OTDR), based on their operating principle, to obtain relative phase change information, which is in turn used to obtain the acoustic/vibration information at each location on the optical fiber. DAS is therefore an array of hundreds or thousands of individual optical microphones, which are all synchronized with one another because they share the same optical source and the same receiver.

Machine learning techniques used to analyze acoustic signals require the generation of particular events of different variants multiple times or manually identifying and labeling events from a large amount of field data to generate a model for this event type, and then recognize future events from the model.

Acoustic models available in an acoustic event library are limited, and it is difficult to expand the acoustic library effectively and quickly. In other words, if an event outside the library list occurs, it will either be missed or incorrectly reported, since the machine learning model of this new event is not available. This limits the function and accuracy of present DFOS/DAS applications and systems.

Therefore, a need exists to expand the acoustic library for DFOS systems to increase detection capability and widen application scope.

### SUMMARY

According to an aspect of the present invention, systems and methods include calibrating physical parameters of acoustic data using a deterministic model related to hardware configurations that generated the acoustic data to provide an intermediate layer of data. The intermediate layer of data is then calibrated using environmental factors related to the acoustic data by employing machine learning to provide a multichannel data output. A loss is optimized between the multichannel data output and multichannel distributed-optic fiber sensing (DFOS) data to train a hybrid transfer model to translate between DFOS data and acoustic data.

According to another aspect of the present invention, a system includes a hardware processor and a memory that stores a computer program which, when executed by the hardware processor, causes the hardware processor to calibrate physical parameters of acoustic data using a deterministic model related to hardware configurations that generated the acoustic data to provide an intermediate layer of data and calibrate the intermediate layer of data using environmental factors related to the acoustic data by employing machine learning to provide a multichannel data output. A loss is optimized between the multichannel data output and multichannel distributed-optic fiber sensing (DFOS) data to train a hybrid transfer model to translate between DFOS data and acoustic data.

According to another aspect of the present invention, a computer program product is described. The computer program product includes a computer readable storage medium storing program instructions embodied therewith, the program instructions executable by a hardware processor cause the hardware processor to: calibrate physical parameters of acoustic data using a deterministic model related to hardware configurations that generated the acoustic data to provide an intermediate layer of data; calibrate the intermediate layer of data using environmental factors related to the acoustic data by employing machine learning to provide a multichannel data output; and optimize a loss between the multichannel data output and multichannel distributed-optic fiber sensing (DFOS) data to train a hybrid transfer model to translate between DFOS data and acoustic data.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method to generate a microphone to distributed-optic fiber sensing (DFOS) transfer model using a hybrid training approach and further showing a generalized DFOS model used for translating between DFOS and acoustic data or scenes, in accordance with an embodiment of the present invention;

FIG. 2 is a block/flow diagram showing a hybrid transfer model in greater detail, in accordance with an embodiment of the present invention;

FIG. 3 is a block/flow diagram showing the hybrid transfer model, in accordance with an embodiment of the present invention;

FIG. 4 is a block/flow diagram illustrating a system for acoustic library generation for distributed fiber optic sensing, in accordance with an embodiment of the present invention; and

FIG. 5 is a flow diagram showing methods for generating an acoustic library for distributed fiber optic sensing, in accordance with an embodiment of the present invention.

### DETAILED DESCRIPTION OF PREFERRED EMBODIMENTS

In accordance with embodiments of the present invention, systems and methods are described that enhance existing sound libraries by providing an adjustable transfer model between an electric microphone, distributed fiber optic sensing (DFOS) and a distributed acoustic sensor (DAS), so that the acoustic model library for DFOS can be generated for more events. The adjustable transfer model can compose new complex events with different background noises and multi-channel events under new conditions making DFOS a system capable of handling many more applications. Then, general-purpose acoustic recognition engines can be trained on this comprehensive dataset.

In an embodiment, controllable generation of new data can be achieved under known environmental conditions and sensor configurations. This permits training of task-specific models under reduced budgets and dedicated for a targeted deployment environment.

Systems and methods can employ an existing acoustic library to generate synthetic multichannel DFOS data according to the needs of different targeted deployment domains (e.g., hardware configurations and environmental conditions) using artificial intelligence (AI), specifically recent techniques related to deep generative models. The data translation includes both physical modeling (for acoustic wave propagation and fiber-optic sensing), as well as adaptation module based on neural networks conditioning with additional input. The calibration can be physics-informed, data-driven, and conditional, enabled by generative adversarial training, feature modulation, and automatic differentiation.

Instead of collecting data and creating a machine learning acoustic model for each event (e.g., create/record or identify/extract/label the event, and train the classification model), existing electric microphone-based sound library can be utilized. The transfer model between the regular microphone and DFOS is built to translate the microphone-based acoustic library to a DFOS-based acoustic library. A hybrid between deterministic and machine learning techniques are employed to make the transfer model adjustable for different hardware and environmental conditions. New event models are composed for the acoustic library using existing events for more complex scenarios. Multi-channel event models can be composed for a synchronized sensor array.

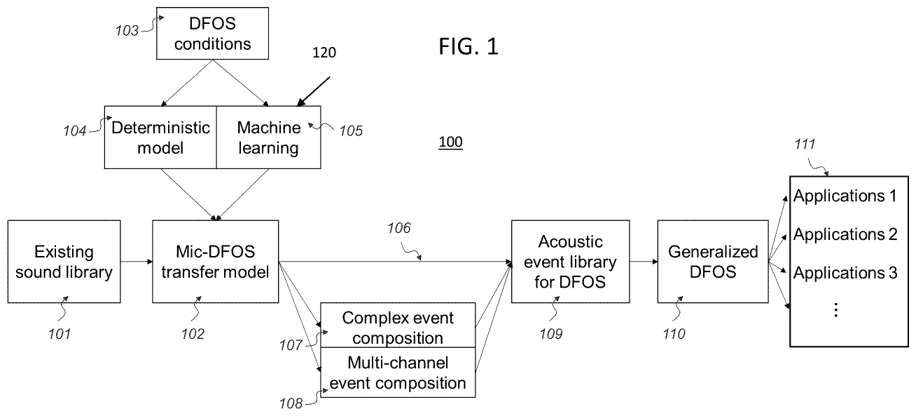

Referring now in detail to the figures in which like-numerals represent the same or similar elements and initially to FIG. 1, a system 100 for training an adjustable acoustic model is shown and described. An existing sound library 101 is employed as a source of acoustic data. Sound sources, such as sound recordings from different animals, different machines, different firearms, different musical instruments, different accidents, different ways of speaking, etc. are available and can be employed. For example, any sound editor for motion pictures has access to a vast amount of sound recordings in the sound library. These sound sources have been labelled and sorted, and may be ready for use. The sound sources can be free or paid sound libraries on the Internet. The sound sources can include new sounds generated and recorded (sound files) using microphones. Since electric microphones are a mature and widely used technology, the fidelity of sound quality is high, even for consumer grade microphones.

A microphone to DFOS transfer model 102 is created. The sound recording files in the existing sound library are all recorded using microphones (e.g., professional grade and/or consumer grade). Response characteristics of a conventional microphone are different from a DFOS acoustic sensor. Therefore, a waveform signal detected by the DFOS may be different from the sound recording files by the microphone. Therefore, a transfer model between equipment of these two detecting methods is needed and is provided in the transfer model 102.

The transfer model 102 is not a fixed model. The characteristics of a DFOS sensor vary under different conditions, such as different weather conditions, different ground conditions, different cable installation configurations, different optoelectronic settings, different optical detection principles, etc. Therefore, the transfer model 102 needs to be dynamic, with customized adjustment to DFOS conditions 103, which can be used as an input to the hybrid model 120.

Therefore, a hybrid model 120 or method with feedback is employed to develop the transfer model 102. The hybrid model 120 includes a deterministic model 104 and a machine learning-generated model 105. The deterministic model 104 is obtained by analyzing optoelectronic characteristics of DFOS hardware. This assumes that audio response characteristics of the microphone are relatively uniform. The audio response characteristics can include, e.g., the frequency response characteristics to acoustic signals, the noise characteristics of the components, the interferometry scheme, etc. A transfer model (deterministic model 104) is generated accordingly.

In some cases, the hardware characteristics of the DFOS system are not provided comprehensively. Live tests with multiple settings can be conducted to collect actual responses of a system, which can, in turn, deduce the hardware transfer model (deterministic model 104).

Some DFOS conditions are not sensor hardware-related, such as the weather and ground condition. Therefore, a machine learning-based method 105 is employed. By training the system with labelled data from different environmental conditions, the hybrid transfer model 120 can be improved to adapt to different conditions.

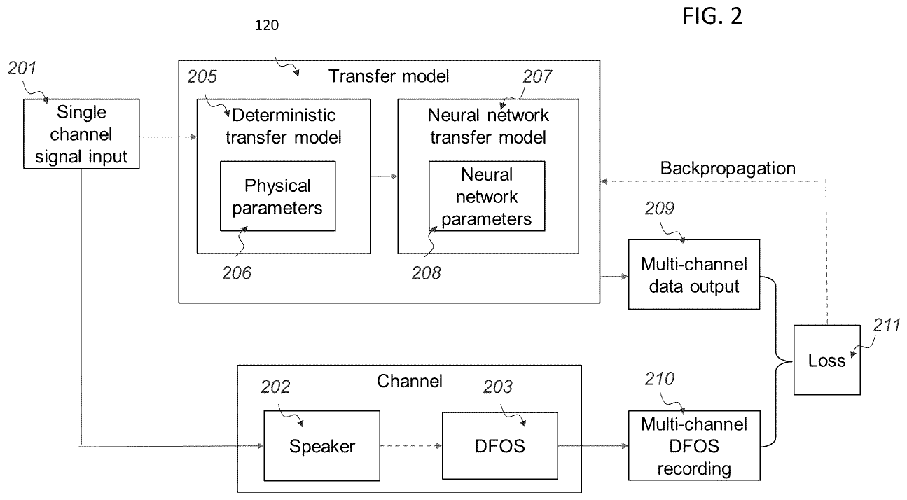

Referring now to FIG. 2, a framework for the generation of the transfer model 120 is further illustrated. Single channel input audio files 201 from a library can be played for several environments using a speaker 202 or other tools, and DFOS 203 picks up the recording and the generated DFOS sensing data is stored. The audio files and DFOS recording need to be synchronized.

The transfer model 120 includes a deterministic model 205 with physical parameters 206 related to hardware configurations, and a neural network model 207 that captures environmental factors. The transfer model 102 is a hybrid model that takes advantage of both domain knowledge of optical sensing and the expressive power of deep neural networks.

In a calibration process, unknown physical parameters 206 and neural network parameters 208 are jointly optimized, by minimizing a discrepancy or loss 211 between a generated data output 209 and an actual DFOS recording 210. The optimization can be supported by automatic differentiation in modern deep learning frameworks. Backpropagation can be employed as feedback to the training of the transfer model 120.

Once the calibration process is completed, new audio inputs are plugged in, and generate new multichannel data outputs 209 without the need of playing and recording in a physical testbed.

The hardware configurations and environmental factors can also be changed to generate new multichannel data outputs under new scenarios in a compositional manner. Complex acoustic scenes can be composed by playing multiple types of sounds together. The hybrid transfer model 120 is calibrated and can include a semi-parametric and physics-infused model.

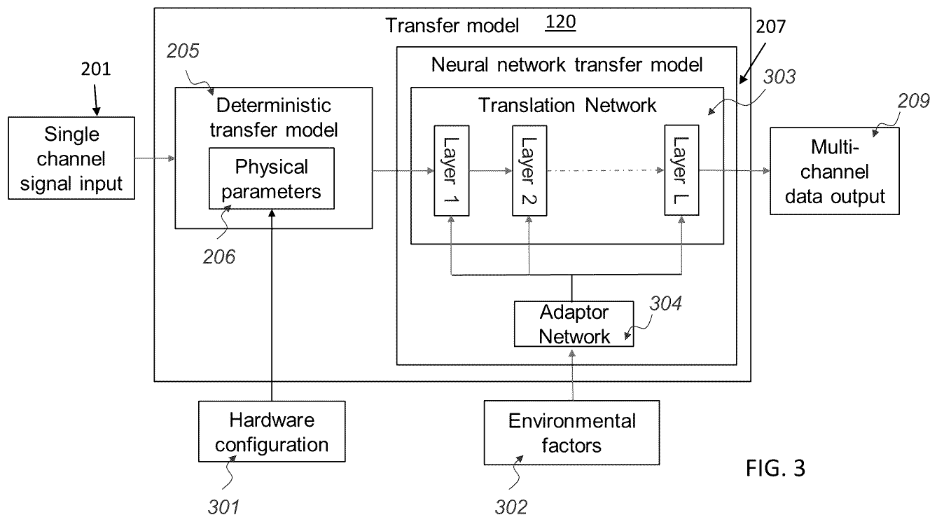

Referring to FIG. 3, the hybrid transfer model 120 is shown in greater detail. The physical parameters 206 are directly controlled by a sensor setup or hardware configuration 301, such as an accumulation cycle, bandpass filter coefficients, amplifier on-off, etc. The hardware configuration 301 is input to the deterministic transfer model 205. Sensor technologies can include, e.g., digital coherent-based DAS, 3×3 interferometer-based DAS, phase-generated carrier-based DAS, etc.

The single channel signal input 201 is first fed in the deterministic transfer model 205 with the configured physical parameters 206. An intermediate layer of data is generated from the deterministic transfer model 205 without considering environmental factors 302. A translation neural network 303 (e.g., U-Net, ViT, or diffusion models) takes the intermediate layer of data as the input, and gradually translates the data into multi-channel DFOS data output 209 that assembles the actual recording by DFOS. The environmental factors 302 can be described in text, such as, e.g., rainy day, asphalt, telecom cable, soil temperature 32° F., etc. In an adaptor neural network 304 (e.g., recurrent neural network or set transformer), these factors are first encoded into embedding vectors, and then fed into a module which outputs scale (γ) and shift (β) parameters for each layer (e.g., 1−L). Therefore, feature maps in the translation network 303 can be adapted to different environmental factors (x) and conditions ( [symbol] ) by the following activation modulation scheme:

$$Activation - Modulation ( x ; ℓ ) = {γ}_{scale}^{ℓ} ( \frac{x - μ ( x )}{σ ( x )} ) + {β}_{shift}^{ℓ}$$

where μ(x) is the mean and σ(x) is the standard deviation).

Artificial Machine learning systems can be used to predict outputs or outcomes based on input data, e.g., fiber optic acoustic data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. Furthermore, ANNs are trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples, can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

Referring again to FIG. 1, with the hybrid deterministic and machine learning scheme, the transfer model 102 between microphone and DFOS can be obtained. This transfer model 102 can be further refined through iterations of feedback adjustment using multiple sets of sound recordings by the microphone and live measurement by DFOS.

With the completion of the transfer model 102, the DFOS acoustic library can be generated. By applying the transfer model 102 to the existing microphone-based sound recording library 101, a sound pattern library can be generated for DFOS by outputting data from the transfer model 106. Since there are different transfer models for different DFOS conditions, different sound pattern libraries can be generated and stored in an acoustic event library 109 for DFOS. This library can include a large amount of DFOS sound patterns in a database for machine learning classification and recognition. The library 109 is generated without the labor intensive, inefficient process of generating the actual sound, recording and labeling the data, and conducting machine learning training for each new acoustic signal.

The present embodiments also provide a configurable DFOS simulator, conditioned on the sensor configuration and environment/medium information. In a forward mode, the DFOS simulator can be used for compositional and controllable generation of new data, based on standard audio inputs. It can also be used in reverse for sensor diagnosis. For example, given the audio file and an unexpected DFOS recording, changes in the sensor configuration can be discovered.

Besides directly generating the acoustic pattern for each sound in the existing sound library, more acoustic complex events 107 can be composed. For example, an event with gunshot firing, people screaming, police siren, and wind noise at the background can be composed by combining these types of sounds to generate a new acoustic pattern for DFOS. This further expands the acoustic library for DFOS. Furthermore, it permits the DFOS to detect and analyze complex events where multiple actions have taken place simultaneously or in sequence. Therefore, the DFOS system not only can provide the information on individual action (e.g., people shouting, firearm firing, police siren running), but also can provide the description of a scene with a series of actions (e.g., a shooter fired 3 shots using a handgun with multiple people screaming for help, after 30 seconds a police car arrived).

The DFOS includes many optical microphones in an array, which is different from an individual microphone. These microphones are intrinsically synchronized together. This is different from an array of discrete microphones, which requires complicated hardware and computation to achieve synchronization in acoustic time scale (millisecond level). Taking the benefit of this feature (intrinsically synchronization among a large amount of microphones operating continuously), multi-channel events 108 can be composed. This provides multi-dimensional event information, such as an event from different projection angles or from different source locations.

With microphones, a user needs to generate sound events at different source locations and collect the acoustic patterns at multiple channels, and use the multiple channels to train the machine learning model. This is time-consuming and inefficient. In accordance with the present invention, acoustic patterns for different locations across multiple optical microphone channels can be generated using the existing sound library 101, the microphone to DFOS transfer model 102, and the knowledge of the fiber installation configuration (e.g., hardware configuration 301). This is extremely efficient, and can quickly adapt to different fiber settings or setting changes (DFOS conditions 103).

After processes 106, 107 and 108, a comprehensive acoustic event library 109 for DFOS can be obtained. The comprehensive acoustic event library 109 is not just for individual sounds, but for scenes and actions for complex events with detailed information such as source direction and location. With this comprehensive acoustic event pattern library 109, the event classification and recognition can be achieved for a greatly expanded number of events. Therefore, the DFOS system is no longer a single-function system or limited-purpose system. A generalized system 110 is realized with universal functionality suitable to detect and recognize any scenes, which contain different events and multiple actions. With this capability, many new or enhanced applications 111 can be created and fulfilled, ranging from safety and security applications for smart city and smart building, production line monitoring in manufacturing facilities, structure health and disaster monitoring in large civil infrastructures, etc.

Application 111 can include acoustic signals (including vibration signals) detected by the DAS. For example, the sound of a rotating machine (such as a pump or a compressor) can be used to analyze its physical health and operation condition, the sound of the vehicle passing a rumble strip can be used to indicate that the vehicle is driving off road, and the vibration pattern received from a buried telecom cable can be used to indicate some construction machine nearby.

In all these applications, the acoustic signals can be analyzed to obtain the event information. Sometimes the analysis can be a frequency analysis (for example, the electric transformer generates a fixed frequency at 60 Hz). More frequently, machine learning techniques can be used to analyze the acoustic signals. This process includes collecting the acoustic signals from the sensor when the particular event is present and when the event is not present (background only), and using machine learning-based classification techniques to train the sensing system to classify this particular type of event.

In accordance with the present invention, the generation of the particular events of different variants multiple times (the more data set available, the more accurate the training result will be), or manually identifying and labeling the event from a large amount of field data can be avoided. In addition, machine learning training processed to generate the model for this event type, and then recognize the future events from the model can be streamlined.

Since for different sensor technology, the obtained acoustic signals are likely to be different, even for the same event. A dedicated training process is required for each sensor hardware. The model might be different under different environmental conditions, such as sunny/dry ground conditions and during rain/wet ground conditions, different soil conditions, different fiber/cable configurations, different burial/installation styles, etc.

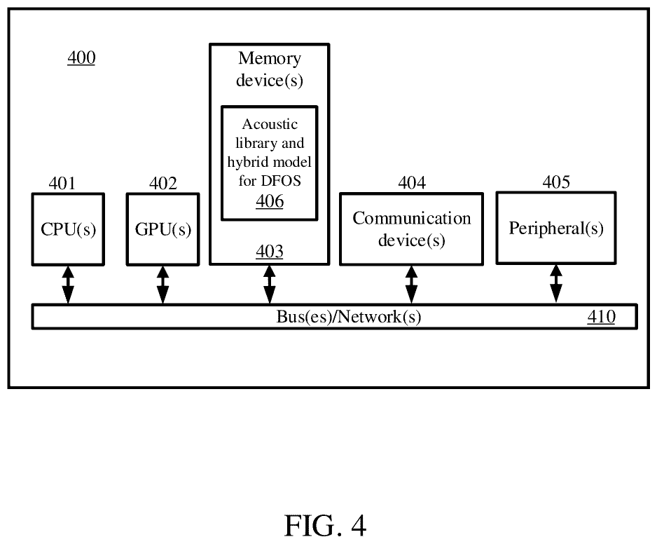

Referring to FIG. 4, a block diagram is shown for an exemplary processing system 400, in accordance with an embodiment of the present invention. The processing system 400 includes a set of processing units (e.g., CPUs) 401, a set of GPUs 402, a set of memory devices 403, a set of communication devices 404, and a set of peripherals 405. The CPUs 401 can be single or multi-core CPUs. The GPUs 402 can be single or multi-core GPUs. The one or more memory devices 403 can include caches, RAMs, ROMs, and other memories (flash, optical, magnetic, etc.). The communication devices 404 can include wireless and/or wired communication devices (e.g., network (e.g., WIFI, etc.) adapters, etc.). The peripherals 405 can include a display device, a user input device, a printer, an imaging device, and so forth. Elements of processing system 400 are connected by one or more buses or networks (collectively denoted by the figure reference numeral 410).

In an embodiment, memory devices 403 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 403 store program code for implementing one or more functions of the systems and methods described herein for programmed software 406 for generating a hybrid model and an acoustic library for distributed fiber optic sensing. The memory devices 403 can store program code for implementing one or more functions of the systems and methods described herein.

Of course, the processing system 400 may also include other elements (not shown), as readily contemplated by one of skill in the art, as well as omitting certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 400 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 400.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

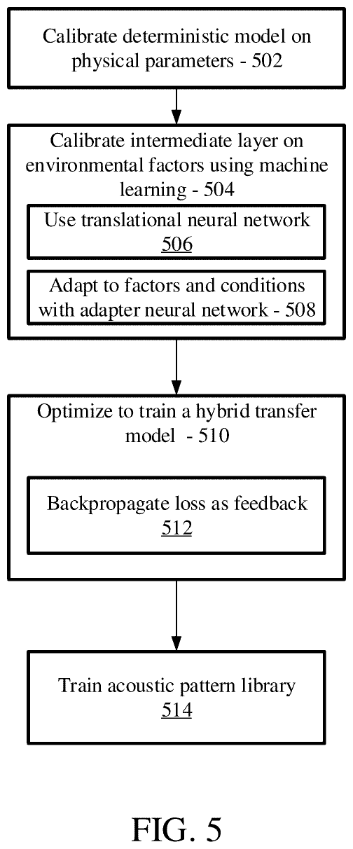

Referring to FIG. 5, a system and computer-implemented methods for generating a hybrid model and an acoustic library for DFOS applications are shown and described in accordance with embodiments of the present invention. In block 502, physical parameters of acoustic data are calibrated using a deterministic model related to hardware configurations that were employed to generate the acoustic data. This calibration outputs an intermediate layer of data. The hardware configurations can include a sensor setup or setups employed to collect the acoustic data, e.g., electric microphone, amplifications, filters, etc. In block 504, the intermediate layer of data is calibrated using environmental factors related to the acoustic data by employing machine learning to provide a multichannel data output. In block 506, the machine learning can include employing a translation neural network that takes the intermediate layer of data and translates the intermediate layer of data into the multichannel data output which includes a recording by DFOS. In block 508, an adaptor neural network can be employed to adapt to different scenarios. The adapter network outputs scale factors and shift factors for layers of the translation neural network to adapt the translation neural network to different environmental factors and conditions.

In block 510, a loss is optimized between the multichannel data output and multichannel DFOS data to train a hybrid transfer model to translate between DFOS data and acoustic data. The multichannel DFOS data can be generated by rendering the acoustic data over a speaker and recording speaker output by DFOS. In block 512, the loss can be used as feedback and backpropagated to the hybrid transfer model to jointly optimize the training.

In block 514, complex events can be employed to train an acoustic event pattern library or acoustic event library with DFOS. The acoustic event pattern library can be trained to provide the hybrid model in accordance with acoustic scenes. The acoustic scenes can include events with a plurality of sounds and actions. These complex scenes can include multiple sounds from multiple sources and the acoustic event library can be employed to identify the sounds and sources. The output could be a natural language description of an acoustic scene. One or more acoustic event libraries can be employed with a generalized DFOS model employed to translate acoustic information to and from DFOS signals in a number of different applications or all applications depending on the level of generalization.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method, comprising:
calibrating physical parameters of acoustic data using a deterministic model related to hardware configurations that generated the acoustic data to provide an intermediate layer of data;
calibrating the intermediate layer of data using environmental factors related to the acoustic data by employing machine learning to provide a multichannel data output; and
optimizing a loss between the multichannel data output and multichannel distributed-optic fiber sensing (DFOS) data to train a hybrid transfer model to translate between DFOS data and acoustic data.

2. The method of claim 1, wherein the hardware configurations include a sensor setup employed to collect the acoustic data.

3. The method of claim 1, wherein employing machine learning includes employing a translation neural network that takes the intermediate layer of data and translates the intermediate layer of data into the multichannel data output which includes a recording by DFOS.

4. The method of claim 3, further comprising an adaptor neural network that outputs scale factors and shift factors for layers of the translation neural network to adapt the translation neural network to different environmental factors and conditions.

5. The method of claim 1, wherein the multichannel DFOS data is generated by rendering the acoustic data over a speaker and recording speaker output by DFOS.

6. The method of claim 1, wherein optimizing the loss includes backpropagating the loss to the hybrid transfer model.

7. The method of claim 1, further comprising generating an acoustic event pattern library by training the hybrid model in accordance with acoustic scenes.

8. The method of claim 7, wherein the acoustic scenes include events with a plurality of sounds and actions.

9. A system, comprising:
a hardware processor; and
a memory that stores a computer program which, when executed by the hardware processor, causes the hardware processor to:
calibrate physical parameters of acoustic data using a deterministic model related to hardware configurations that generated the acoustic data to provide an intermediate layer of data;
calibrate the intermediate layer of data using environmental factors related to the acoustic data by employing machine learning to provide a multichannel data output; and
optimize a loss between the multichannel data output and multichannel distributed-optic fiber sensing (DFOS) data to train a hybrid transfer model to translate between DFOS data and acoustic data.

10. The system of claim 9, wherein the hardware configurations include a sensor setup employed to collect the acoustic data.

11. The system of claim 9, wherein the computer program further causes the hardware processor to employ machine learning by employing a translation neural network that takes the intermediate layer of data and translates the intermediate layer of data into the multichannel data output which includes a recording by DFOS.

12. The system of claim 11, further comprising an adaptor neural network that outputs scale factors and shift factors for layers of the translation neural network to adapt the translation neural network to different environmental factors and conditions.

13. The system of claim 9, wherein the multichannel DFOS data is generated by rendering the acoustic data over a speaker and recording speaker output by DFOS.

14. The system of claim 9, wherein the computer program further causes the hardware processor to optimize the loss by backpropagating the loss to the hybrid transfer model.

15. The system of claim 9, further comprising an acoustic event pattern library generated by training the hybrid model in accordance with acoustic scenes.

16. The system of claim 15, wherein the acoustic scenes include events with a plurality of sounds and actions.

17. A computer program product, the computer program product comprising a computer readable storage medium storing program instructions embodied therewith, the program instructions executable by a hardware processor to cause the hardware processor to:
calibrate physical parameters of acoustic data using a deterministic model related to hardware configurations that generated the acoustic data to provide an intermediate layer of data;
calibrate the intermediate layer of data using environmental factors related to the acoustic data by employing machine learning to provide a multichannel data output; and
optimize a loss between the multichannel data output and multichannel distributed-optic fiber sensing (DFOS) data to train a hybrid transfer model to translate between DFOS data and acoustic data.

18. The computer program product of claim 17, wherein the computer program product further causes the hardware processor to employ a translation neural network that takes the intermediate layer of data and translates the intermediate layer of data into the multichannel data output which includes a recording by DFOS.

19. The computer program product of claim 18, wherein the computer program product further causes the hardware processor to employ an adaptor neural network to output scale factors and shift factors for layers of the translation neural network to adapt the translation neural network to different environmental factors and conditions.

20. The computer program product of claim 17, wherein the computer program product further causes the hardware processor to optimize the loss by backpropagating the loss to the hybrid transfer model.
